(19) United States
(12) Patent Application Publication
(10) Pub. No.: US 2017/0131980 A1
(43) Pub. Date: May 11, 2017

(54) MODEL DRIVEN ARCHITECTURE FOR NETWORK MANAGEMENT AND CONFIGURATION

(71) Applicant: rift.IO, Inc., Burlington, MA (US)

(72) Inventors: Rajesh VELANDY, Westford, MA (US); Vinod Kamalaraj, Shirley, MA (US); Thomas Seidenberg, Lancaster, MA (US); Grant Taylor, Harvard, MA (US); Anil Gunturu, Lexington, MA (US); Matthew Hayden Harper, Hollis, NH (US); Thimothy Glenn Mortsolf, Amherst, MA (US)

(21) Appl. No.: 14/935,017

(22) Filed: Nov. 6, 2015

(51) Int. Cl. G06F 9/45; G06F 9/44; G06F 17/30

(52) U.S. Cl. CPC G06F 8/41; G06F 17/30923; G06F 8/35

(57) ABSTRACT

Systems, methods, and computer program embodiments are disclosed for managing network configuration and operational state data in a data network. In an embodiment, a data schema defined in a data modeling language may be received. The data schema may contain one or more data nodes describing network configuration and operational state data. The data schema may then be translated to a data definition for a serializable data structure. The data definition may be compiled into a first binding for a first programming language and a second binding for a second programming language. The first and second bindings may include accessors for accessing data of the serializable data structure.

### BACKGROUND

Field

Embodiments of the systems and methods described herein are generally related to data network management.

Background

In recent years, there has been a push to drive the configuration and runtime management of networking applications from a conceptual data model. However, the internal data structures used by the networking applications may not conform to the defined data model. A network management system may communicate with network device elements and external systems in a data network via a network management protocol. Messages sent and received via the network management protocol may conform to the conceptual data model, but networking applications may require a translation to be applied to map the messages to the internal data structures of the networking applications.

This approach is inefficient and may require significant processing power. Further, network management systems may include network management software written in multiple languages, requiring multiple translations for each received network management protocol message. A solution is needed that synchronizes the internal data structures of networking applications with the conceptual data model and enables efficient communication between network management components.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating an example network management architecture, according to an embodiment.

FIG. 2 is an example network management system 200 for managing network configuration and operational state data in a data network, according to an embodiment.

FIG. 3 is a diagram illustrating example data definitions generated from a network data schema, according to an embodiment.

FIG. 4 is a diagram illustrating example communication and data flow between network system management components, according to an embodiment.

FIG. 5 is an example method for managing network configuration and operational state data in a data network, according to an embodiment.

FIG. 6 is an example method for converting a serializable data structure to a message comporting with an employed network management protocol, according to an embodiment.

FIG. 7 is an example method for converting a plurality of data received from one or more network device elements to a serializable data structure, according to an embodiment.

FIG. 8 is a diagram illustrating an example computing device, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

### Example Network Management System

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

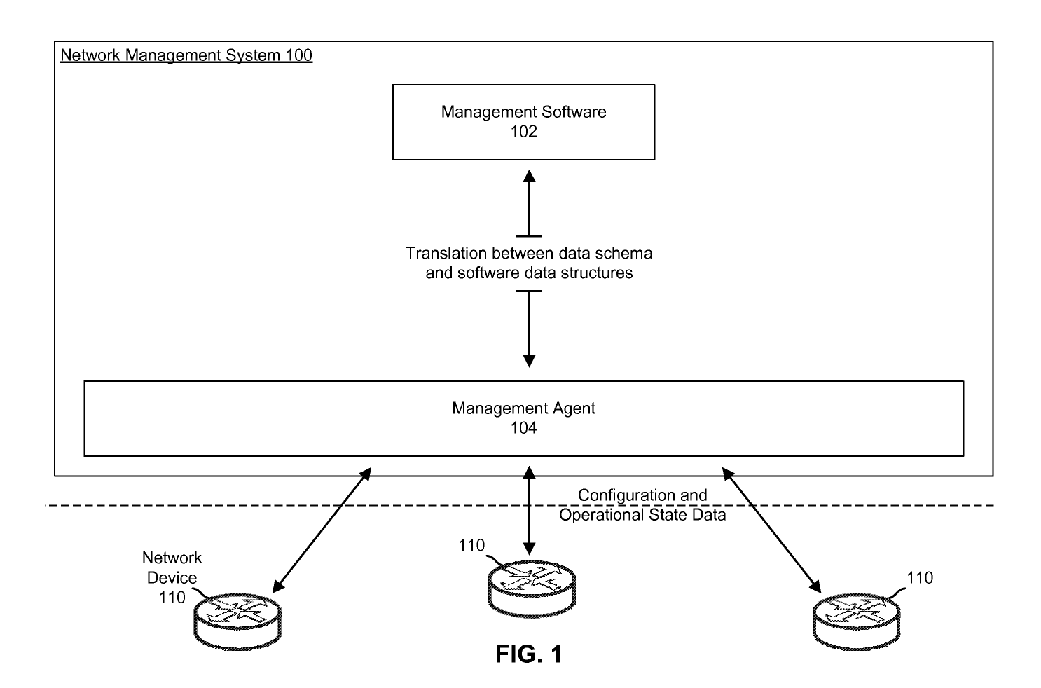

FIG. 1 is a diagram illustrating an example network management architecture 100, according to an embodiment. Network management system 100 may include core network management software 102 and a management agent 104. Network management system 100 may also be coupled to one or more network device elements 110 in a data network. Management agent 104 may communicate with network device elements 110 via a network management protocol, such as but not limited to, NETCONF and SNMP, as well as with external systems and applications.

As networks become more complex and heterogeneity increases among network device elements, network data modeling languages have simplified development of networking applications. Network data modeling languages, for example YANG, enable defining of a schema to represent network configuration and operational state data. Application developers may then use the defined data schema to implement networking applications in various languages that monitor and manipulate network configuration and state data. However, the internal data structures used in management software 102 may not emulate this data schema. For example, data from network device elements 110 or external systems may be received by management agent 104 and conform to an employed network management protocol. In order for management software 102 to consume this data, a translation may need to be applied to convert the received data to the internal data structures of the software. This translation adds latency and may require significant processing power.

In order to simplify this translation, management software 102 may implement internal data structures to mirror the defined data schema. While this reduces the complexity of mappings between external and internal data structures, a large amount of data must still be transferred between network management components, and parsing this data may be inefficient. For example, messages received via the NETCONF protocol may be in the form of an extensible markup language (XML) encoded document. These XML encoded documents may be large in size and inefficient to parse. Furthermore, any changes to the data schema require that the translation mappings and/or internal data structures be updated. If manual updating is required, this may add significant complexity to large network management systems.

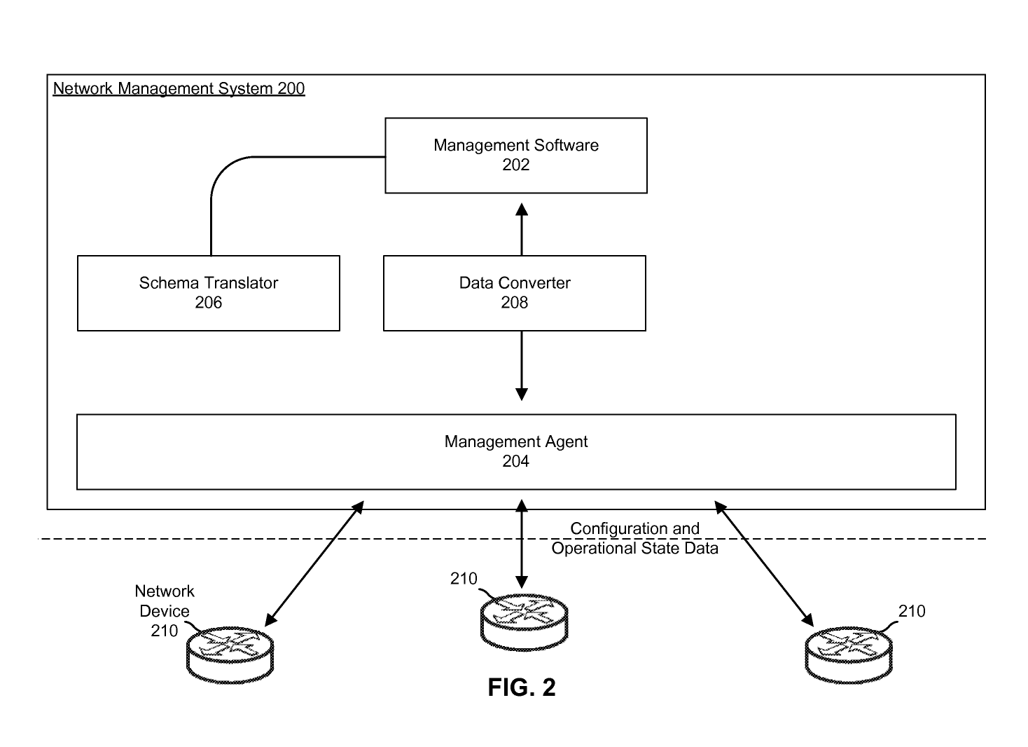

FIG. 2 is an example network management system 200 for managing network configuration and operational state data in a data network, according to an embodiment. Network management system 200 may enable the structure of network configuration and state data to be defined and synchronized across network management components and applications. Network management system 200 may include management software 202, management agent 204, schema translator 206, and data converter 208. Network management system 200 may also be coupled to one or more network device elements 210.

In an embodiment, schema translator 206 enables automatic generation of internal data structures within management software 202 from a data schema. The data schema may be defined in a network data modeling language such as, but not limited to, YANG. In an embodiment, schema translator 206 may first translate the data schema to a data definition for a serializable data structure such as, but not limited to, a GOOGLE Protocol Buffer data definition, used for inter-process communication within management software 202. A serializable data structure may be used for efficient communication between components. Management software 202 may include multiple components defined in various programming languages. Schema translator 206 may then use the data definition to generate internal object definitions for each of the programming languages and language-specific bindings for accessing the serializable data structure, as will be discussed in more detail below. For example, schema translator 206 may generate internal data structures and language-specific bindings for a networking application written in the C programming language that mirror the data schema defined by the network data modeling language. This may allow separate network management components to read data from and write data to serializable data structures.

In an embodiment, data converter 208 enables conversion of data external to the system to a serializable data structure, and vice versa. Data received by network management system 200 may conform to a format specified by a particular network management protocol. For example, a NETCONF message received from a network device element 210 or an external system may be in the form of a NETCONF-compatible XML encoded document. Data converter 208 may convert this document into a serializable data structure, which in turn is automatically accessible via language bindings in management software 202 previously generated by schema translator 206. In this manner, no translation mappings between external data and internal software data structures may be needed.

Likewise, data converter 208 may convert a serializable data structure written by management software 202 to a network management protocol-compatible format, such as a NETCONF-compatible XML encoded document. This document may then be sent by management agent 204 to one or more network device elements 210, to an external system or application, or any combination thereof. In an embodiment, data converter 208 may validate both external data and internal serializable data structures for compliance with the defined data schema.

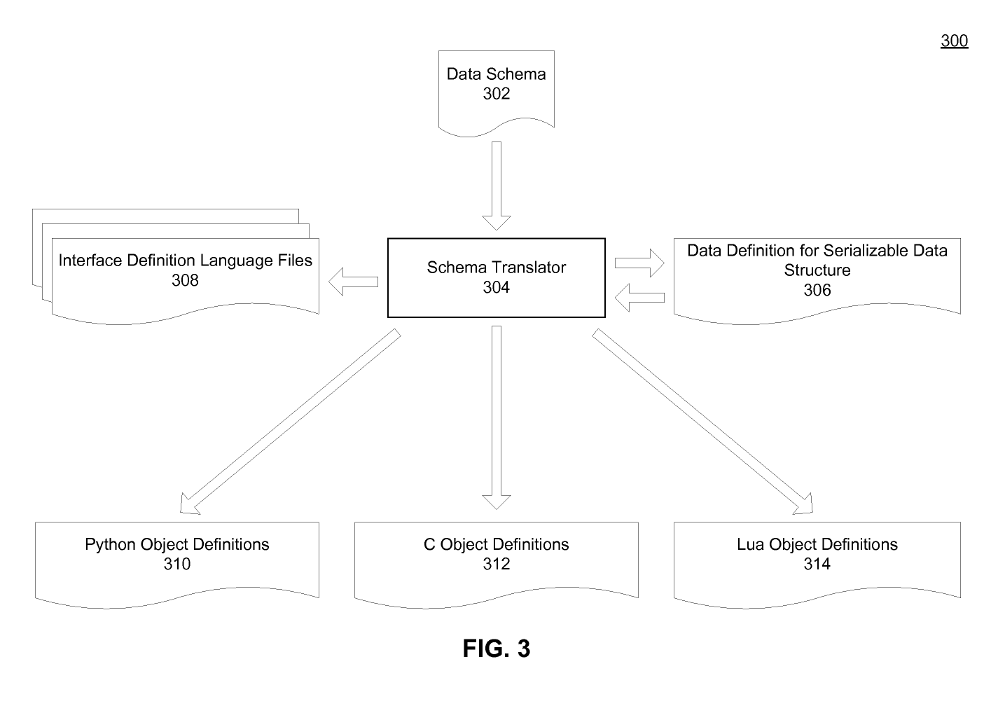

FIG. 3 is a diagram illustrating example data definitions generated from a network data schema, according to an embodiment. In an embodiment, a data schema 302 specifying the structure of network configuration and operational state data may be defined in a network data modeling language such as, but not limited to, YANG. Data schema 302 may include one or more data nodes that describe the network configuration and operational state data. In an embodiment, the data nodes may be structured hierarchically. Data schema 302 may be used by network management protocols by acting as a contract between a network management system and network device elements or external systems. In this manner, data exchanged between the network management system and external network elements can be expected to conform to data schema 302.

In an embodiment, data schema 302, once defined, is passed to schema translator 304. Schema translator 304 may then translate data schema 302 to a data definition for a serializable data structure 306. In an embodiment, data definition 306 may be constructed for a data serialization framework such as, but not limited to, GOOGLE Protocol Buffers, APACHE THRIFT, or APACHE AVRO.

In an embodiment, data schema 302 may include a plurality of extensions that direct the translation to data definition 306. Example extensions may include, according to an embodiment:

A data-new extension that specifies a particular data node of data schema 302 should be included at the top-level scope within data definition 306.

A field-name extension that specifies a field name to be used within data definition 306 for a particular data node of data schema 302.

A field-type extension that specifies a type to be used within data definition 306 for a particular data node of data schema 302.

A field-tag extension that specifies a tag number or column number for a field within data definition 306 corresponding to a particular data node of data schema 302.

In an embodiment, schema translator 304 may compile data definition 306 into internal object definitions for one or more programming languages. Each programming language may be used to develop various network management components or applications within a network management system. In the example illustrated in FIG. 3, schema translator 304 may compile data definition 306 into Python object definitions 310, C object definitions 312, and Lua object definitions 314. For example, C object definitions 312 may include C source and header files defining structures containing the same fields and hierarchical structure as defined in data schema 302. Object definitions 310-314 may additionally include language-specific bindings for accessing data within a serializable data structure. For example, C object definitions may include getter and setter methods for accessing fields defined in data definition 306.

In an embodiment, data schema 302 may include a plurality of extensions that direct the compilation of data definition 306 to internal object definitions for the one or more programming languages. These extensions may be passed from schema object 302 to data definition 306. Example extensions may include, according to an embodiment:

A data-flat extension that specifies memory be explicitly allocated for each internal object definition and contained fields/attributes. For example, when compiling data definition 306 into C object definitions, this extension may specify to allocate memory for each defined structure, variable, and function.

A field-inline extension that specifies explicit memory be allocated for a particular field. For example, when compiling data definition 306 into C object definitions, this extension will prevent a particular variable from being defined as a pointer.

A field-inline-max extension that specifies the maximum size of a particular repeated field, for example an array.

A field-string-max extension that specifies the maximum size of a particular text field, for example a character array.

In an embodiment, schema translator 304 may also generate one or more interface definition language (IDL) files 308 that define an interface based on the data schema. In a further embodiment, one or more IDL files 308 may be compiled into a binary library, and cross-language bindings for each programming language (e.g., Python, C, and Lua) may be generated to enable communication via the binary library. Rather than communicate between components written in different languages via a serializable data structure, the generated cross-language bindings and binary library may enable a management component or application to directly invoke functionality of another component or application. For example, a core management application may be developed in C, and a testing framework may be developed in Python. Using the generated cross-language bindings, the testing framework may be able to directly invoke methods and other subroutines of the core management application defined in the binary library for testing purposes. In an embodiment, the binary library may be dynamically linked at runtime of a management application.

An example of middleware that provides cross-language bindings between multiple programming languages is GObject Introspection maintained by THE GNOME PROJECT. In this example, one or more IDL files may be generated that reflect functionality defined in C object definitions 312. The IDL files may be compiled into a GObject binary library, and cross-language bindings may be generated for Python and Lua that may be used to make calls to the GObject library. One of skill in the art will recognize that GObject Introspection is used by way of example, and other frameworks and software components may be used in addition or as alternatives.

Data schema 302 may be updated periodically to reflect changes within a network. In an embodiment, schema translator 304 may detect updates to data schema 302 and automatically retranslate data schema 302 to a new data definition for a serializable data structure. In an embodiment, schema translator 304 may retranslate data schema 302 to a new data definition in response to manual input, for example by a network administrator. Schema translator 304 may then compile the new data definition into a new object definitions for each of the programming languages that include new bindings for accessing data within a serializable data structure. In this manner, data schema 302 may be updated without requiring manual updates to other components of a network management system. Additionally, in the case that one or more management components are not properly updated, schema translator 302 may ensure backward compatibility of software versions, according to an embodiment. For example, in an embodiment, each field may have a default value, and extra fields defined in schema translator 302 may be ignored during translation.

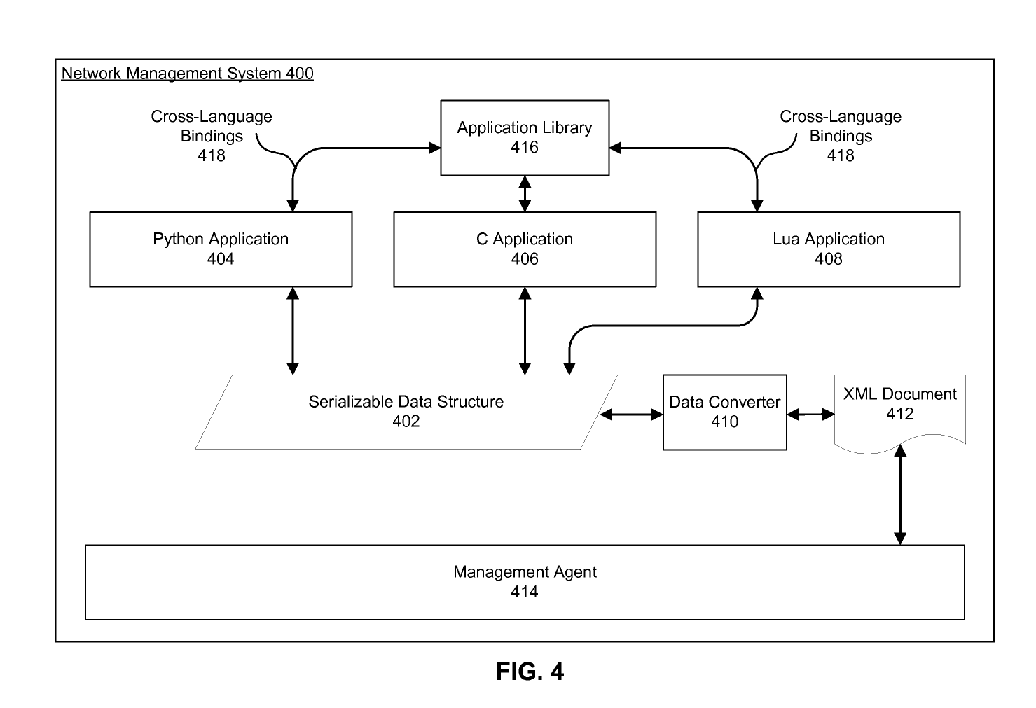

FIG. 4 is a diagram illustrating example communication and data flow between network system management components, according to an embodiment. Network management system 400 may include serializable data structure 402, Python application 404, C application 406, Lua application 408, data converter 410, XML document 412, management agent 414, application library 416, and cross-language bindings 418.

In an embodiment, serializable data structure 402 may contain data fields defined by a data definition, such as data definition 306 of FIG. 3. Serializable data structure 402 may be serialized and used to communicate on the wire among management components and applications, such as Python application 404, C application 406, and Lua application 408. In an embodiment, applications 404-408 may represent network management applications internal to network management system 400. The internal data structures of each application may be automatically generated from a data schema, such as data schema 302 of FIG. 3, by a schema translator, such as schema translator 304 of FIG. 3. In an embodiment, applications 404-408 may include language-specific bindings to read data from or write data to serializable data structure 402.

In an embodiment, applications 404-408 may also communicate via cross-language bindings 418 and application library 416. Application library 416 and cross-language bindings 418 may be generated by compiling one or more IDL files, such as IDL file 308 of FIG. 3. Application library 416 may include a plurality of subroutines that invoke functionality of Python application 404, C application 406, and/or Lua application 408. Application library may be useful in making direct calls from one application to another, rather than communicating via serializable data structure 402.

In an embodiment, management agent 414 sends and receives data external to network management system 400. For example, management agent 414 may send data to and receive data from other network device elements. Data may be communicated over one or more network management protocols such as, but not limited to, NETCONF and SNMP. In the example illustrated in FIG. 4, an XML encoded document 412 comporting with one of the network management protocols may be sent and received by management agent 414. XML encoded document 412 is used by way of example, but other network management protocol-compatible formats for encoding messages may similarly be used.

When an XML encoded document 412 is received by management agent 414, data converter 410 may convert XML document 412 to a serializable data structure 402 accessible by applications 404-408 via language-specific bindings. For example, XML document 412 may contain configuration data and status information for a plurality of routers within a data network. Data converter 410 may validate XML document 412 for compliance with a defined data schema, such as data schema 302 of FIG. 3, and convert XML document 412 to a serializable data structure 402. Python application 404, C application 406, and Lua application 408 may then access and manipulate this data through serializable data structure 402.

Applications 404-408 may also create or write to a serializable data structure 402. For example, C application 406 may define configuration data to be deployed on one or more network device elements in a data network, and this data may be written to a serializable data structure 402. Data converter 410 may then validate data structure 402 for compliance with a defined data schema, such as data schema 302 of FIG. 3, and convert data structure 402 to an XML encoded document 412. This document may in turn be sent via a network management protocol to the appropriate network device elements.

In an embodiment, data converter 410 may convert a plurality of received messages encoded in XML documents 412 to a single serializable data structure 402. For example, a request may be submitted from network management system 400 to retrieve configuration data for all routers within a data network. In this example, management agent 414 may receive an XML encoded response from each router in the network. Data converter 410 may merge the plurality of XML encoded documents into a single XML tree and validate the tree for compliance with a defined data schema. If the tree is determined to be valid, data converter 410 may then convert the XML tree to a corresponding serializable data structure 402. In this manner, configuration data from each router within the network may be analyzed by applications 404-408 as a single collection of data.

In an embodiment, XML document 412 may be saved by network management system 400 and written to a management database. Management database may be a part of or external to network management system 400. This may be useful to save or back up configuration information internal to network management system 400.

### Example Method

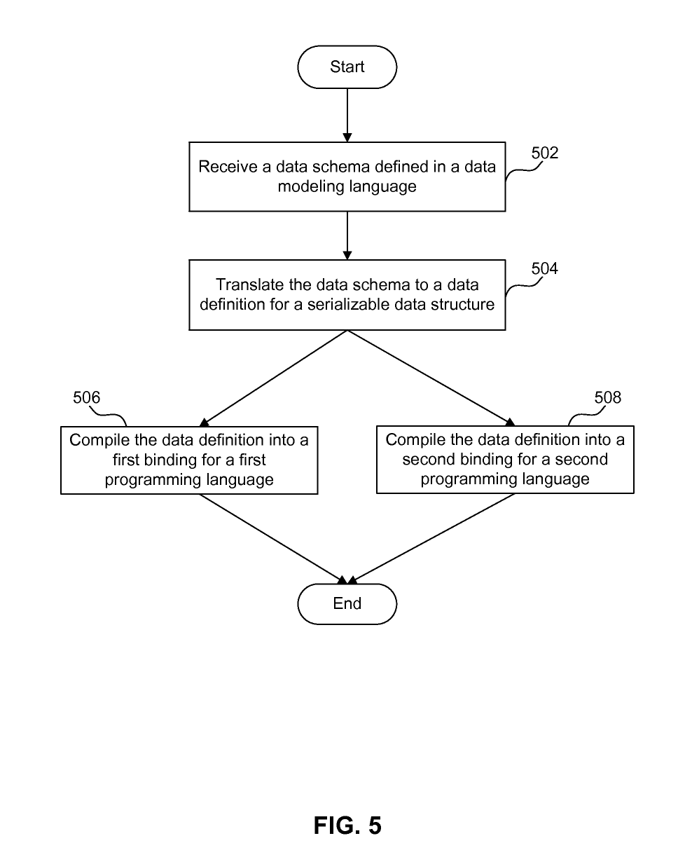

FIG. 5 is an example method for managing network configuration and operational state data in a data network, according to an embodiment. Method 500 begins at stage 502 by receiving a data schema defined in a data modeling language. In an embodiment, the data schema may include one or more data nodes that describe network configuration and operational state data in the data network.

At stage 504, the data schema may be automatically translated to a data definition for a serializable data structure. In an embodiment, the data definition may be constructed for a data serialization framework such as, but not limited to, GOOGLE Protocol Buffers, APACHE THRIFT, or APACHE AVRO. The serializable data structure may provide and efficient means for exchanging data on the wire among network management components and applications.

At stage 506, the data definition may be compiled into a first binding for a first programming language. At stage 508, the data definition may then be compiled into a second binding for a second programming language. Each programming language may be used to develop various network management components and applications within a network management system. In an embodiment, the generated bindings may include getter and setter methods for accessing fields of a serializable data structure defined in the data definition. This may allow separate network management components to read data from and write data to serializable data structures.

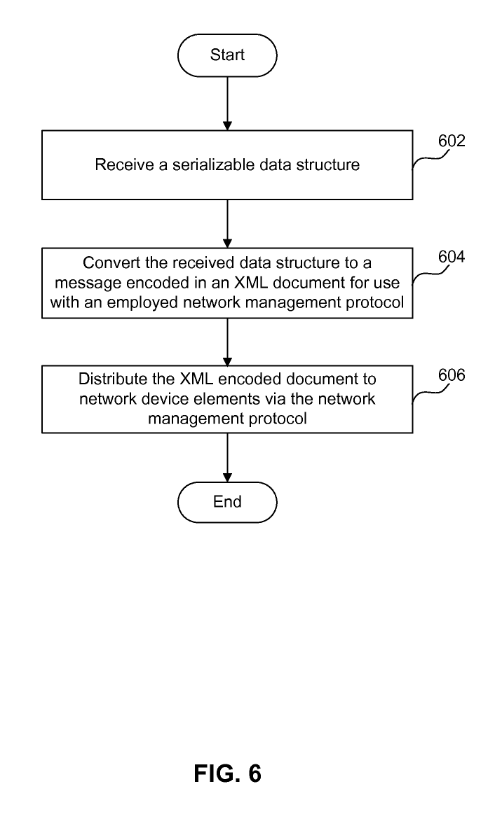

FIG. 6 is an example method for converting a serializable data structure to a message comporting with an employed network management protocol, according to an embodiment. Method 600 begins at stage 602 by receiving a serializable data structure. For example, a network management application may define configuration data to be deployed on one or more network device elements in a data network, and this data may be written to a serializable data structure.

At stage 604, the received data structure may be converted to an XML encoded document for use with an employed network management protocol. For example, the received data structure may be parsed and converted to a NETCONF-compatible XML encoded document to be sent as a NETCONF message. At step 606, the XML encoded document may be distributed to one or more network device elements via the employed network management protocol. XML encoded documents are used by way of example, but the received data structure may similarly be converted to other network management protocol-compatible formats for encoding messages.

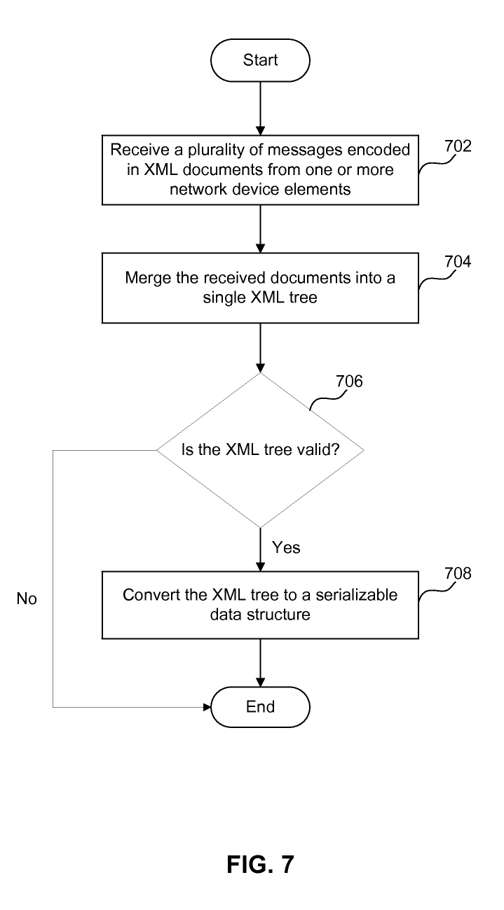

FIG. 7 is an example method for converting a plurality of data received from one or more network device elements to a serializable data structure, according to an embodiment. Method 700 begins at stage 702 by receiving a plurality of messages encoded in XML documents from one or more network device elements. For example, a request may be submitted to retrieve configuration data for all routers within a data network. In this example, an XML encoded response from each router in the network may be received.

At stage 704, the plurality of received XML encoded documents may be merged into a single XML tree. At stage 706, it is determined whether the XML tree is valid based on a defined data schema, such as data schema 302 of FIG. 3. At stage 708, if the XML tree is determined to be valid, the XML tree may be converted to a corresponding serialized data structure. In this manner, configuration data from each router within the network may be analyzed by network management applications as a single collection of data.

### Example Computer System

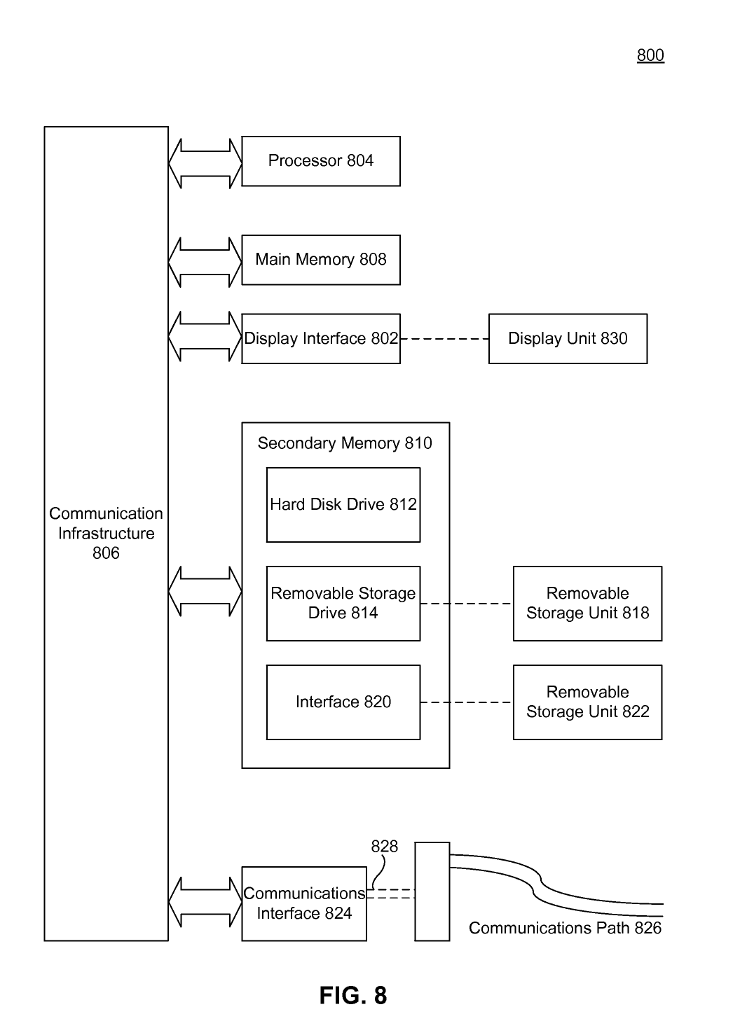

FIG. 8 is an example computing system useful for implementing various embodiments. Various embodiments can be implemented, for example, using one or more well-known computer systems, such as computer system 800. Computer system 800 can be any well-known computer capable of performing the functions described herein, such as computers available from International Business Machines, Apple, Sun, HP, Dell, Sony, Toshiba, etc.

Computer system 800 includes one or more processors (also called central processing units, or CPUs), such as a processor 804. Processor 804 may be connected to a communication infrastructure or bus 806.

One or more processors 804 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 800 also includes user input/output device(s) 803, such as monitors, keyboards, pointing devices, etc., which communicate with communication infrastructure 806 through user input/output interface(s) 802.

Computer system 800 also includes a main or primary memory 808, such as random access memory (RAM). Main memory 808 may include one or more levels of cache. Main memory 808 has stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/or any other computer data storage device. Removable storage drive 814 reads from and/or writes to removable storage unit 818 in a well-known manner.

According to an exemplary embodiment, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In an embodiment, a tangible apparatus or article of manufacture comprising a tangible computer useable or readable medium having control logic (software) stored thereon is also referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 8. In particular, embodiments may operate with software, hardware, and/or operating system implementations other than those described herein.

### CONCLUSION

Identifiers, such as “(a),” “(b),” “(i),” “(ii),” etc., are sometimes used for different elements or steps. These identifiers are used for clarity and do not necessarily designate an order for the elements or steps.

Embodiments of the present inventions have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the inventions that others can, by applying knowledge within the skill of the art, readily modify and/or adapt for various applications such specific embodiments, without undue experimentation, without departing from the general concept of the present inventions. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present inventions should not be limited by any of the above-described embodiments, but should be defined only in accordance with the following claims and their equivalents.

What is claimed is:

1. A network management system for managing network configuration and operational state data in a data network, comprising:
one or more computing devices; and
a schema translator, implemented on the one or more computing devices, configured to:
receive a data schema defined in a data modeling language, the data schema containing one or more data nodes describing network configuration and operational state data;
translate the data schema to a data definition for a serializable data structure;
compile the data definition into a first binding for a first programming language, the first binding including accessors for accessing data of the serializable data structure; and
compile the data definition into a second binding for a second programming language, the second binding including accessors for accessing data of the serializable data structure.

2. The network management system of claim 1, further comprising:
a data converter, implemented on the one or more computing devices, configured to:
receive a serializable data structure, wherein the serializable data structure is accessible via the first binding of the first programming language and the second binding of the second programming language; and
convert the received data structure to a message comporting with an employed network management protocol; and
a management agent, implemented on the one or more computing devices, configured to distribute the message to one or more network devices via the network management protocol.

3. The network management system of claim 2, wherein the message is encoded in an extensible markup language (XML) document.

4. The network management system of claim 1, further comprising:
a management agent, implemented on the one or more computing devices, configured to receive a message from a network device via a network management protocol, the message comporting with the network management protocol; and
a data converter, implemented on the one or more computing devices, configured to:
receive the message from the management agent; and
convert the message to a serializable data structure, wherein the serializable data structure is accessible via the first binding of the first programming language and the second binding of the second programming language.

5. The system of claim 1, wherein the schema translator is further configured to:
generate one or more interface definition language files that define an interface based on the data schema;
compile the one or more interface definition language files into a binary library; and
generate cross-language bindings for the first and second programming languages that enable communication between components defined in the first programming language and components defined in the second programming language via the binary library.

6. The system of claim 1, wherein the schema translator is further configured to:
detect an update to the data schema;
retranslate the data schema to a new data definition for a serializable data structure in response to the detected update;
compile the new data definition into a new binding for the first programming language in response to the detected update; and
compile the new data definition into a new binding for the second programming language in response to the detected update.

7. The system of claim 1, wherein the data schema includes one or more extensions that direct the translation of the data schema to the data definition for the serialized data structure, and wherein the schema translator is further configured to translate the data schema based on the one or more extensions.

8. The system of claim 1, wherein the data schema includes one or more extensions that direct the compilation of the data definition to the first and second bindings, and wherein the schema translator is further configured to compile the data definition based on the one or more extensions.

9. The system of claim 1, wherein the data converter is further configured to:
convert a serializable data structure to an XML encoded document; and
write the XML document to a management database.

10. The system of claim 1, wherein the data converter is further configured to:
receive a plurality of messages from one or more network devices via a network management protocol, wherein the plurality of messages are XML encoded documents containing data corresponding to the data schema;
merge the plurality of received messages into a single XML tree;
determine whether the XML tree is valid based on the data schema; and
convert the XML tree to a corresponding serializable data structure in response to determining that the XML tree is valid, wherein the serializable data structure is accessible via the first binding of the first programming language and the second binding of the second programming language;

11. A method for managing network configuration and operational state data in a data network, comprising:
receiving a data schema defined in a data modeling language, the data schema containing one or more data nodes describing network configuration and operational state data;
translating the data schema to a data definition for a serializable data structure;
compiling the data definition into a first binding for a first programming language, the first binding including accessors for accessing data of the serializable data structure; and
compiling the data definition into a second binding for a second programming language, the second binding including accessors for accessing data of the serializable data structure.

12. The method of claim 11, further comprising:
receiving a serializable data structure, wherein the serializable data structure is accessible via the first binding of the first programming language and the second binding of the second programming language;
converting the received data structure to a message comporting with an employed network management protocol; and
distributing the message to one or more network devices via the network management protocol.

13. The method of claim 12, wherein the message is encoded in an XML document.

14. The method of claim 11, further comprising:
receiving an XML encoded document from a network device via a network management protocol, the message comporting with the network management protocol;
converting the message to a serializable data structure, wherein the serializable data structure is accessible via the first binding of the first programming language and the second binding of the second programming language.

15. The method of claim 11, further comprising:
generating one or more interface definition language files that define an interface based on the data schema;
compiling the one or more interface definition language files into a binary library; and
generating cross-language bindings for the first and second programming languages that enable communication between components defined in the first programming language and components defined in the second programming language via the binary library.

16. The method of claim 11, further comprising:
detecting an update to the data schema;
retranslating the data schema to a new data definition for a serializable data structure in response to the detected update;
compiling the new data definition into a new binding for the first programming language in response to the detected update; and
compiling the new data definition into a new binding for the second programming language in response to the detected update.

17. The method of claim 11, wherein the data schema includes one or more extensions that direct the translation of the data schema to the data definition for the serialized data structure, and wherein the schema translator is further configured to translate the data schema based on the one or more extensions.

18. The method of claim 11, wherein the data schema includes one or more extensions that direct the compilation of the data definition to the first and second bindings, and wherein the schema translator is further configured to compile the data definition based on the one or more extensions.

19. The method of claim 11, further comprising:
converting a serializable data structure to an XML encoded document; and
writing the XML document to a management database.

20. The method of claim 11, further comprising:
receiving a plurality of messages from one or more network devices via a network management protocol, wherein the plurality of messages are XML encoded documents containing data corresponding to the data schema;
merging the plurality of received messages into a single XML tree;
determining whether the XML tree is valid based on the data schema; and
converting the XML tree to a corresponding serializable data structure in response to determining that the XML tree is valid, wherein the serializable data structure is accessible via the first binding of the first programming language and the second binding of the second programming language;

21. A non-transitory computer-readable storage device having instructions stored thereon that, when executed by at least one computing device, causes the at least one computing device to perform operations comprising:
receiving a data schema defined in a data modeling language, the data schema containing one or more data nodes describing network configuration and operational state data;
translating the data schema to a data definition for a serializable data structure;
compiling the data definition into a first binding for a first programming language, the first binding including accessors for accessing data of the serializable data structure; and
compiling the data definition into a second binding for a second programming language, the second binding including accessors for accessing data of the serializable data structure.

22. The computer-readable storage device of claim 21, further comprising:
generating one or more interface definition language files that define an interface based on the data schema;
compiling the one or more interface definition language files into a binary library; and
generating cross-language bindings for the first and second programming languages that enable communication between components defined in the first programming language and components defined in the second programming language via the binary library.

23. The computer-readable storage device of claim 21, further comprising:
detecting an update to the data schema;
retranslating the data schema to a new data definition for a serializable data structure in response to the detected update;
compiling the new data definition into a new binding for the first programming language in response to the detected update; and
compiling the new data definition into a new binding for the second programming language in response to the detected update.
